(19) United States
(12) Patent Application Publication
(10) Pub. No.: US 2013/0337321 A1
(43) Pub. Date: Dec. 19, 2013

(54) POSITIVE ELECTRODE FOR NONAQUEOUS ELECTROLYTE SECONDARY BATTERY, METHOD FOR PRODUCING THE POSITIVE ELECTRODE, AND NONAQUEOUS ELECTROLYTE SECONDARY BATTERY USING THE POSITIVE ELECTRODE

(71) Applicants: Hiroyuki Matsumoto, Frisco, TX (US); Takeshi Ogasawara, Kobe City (JP); Daizo Jito, Kobe City (JP); Takao Kokubu, Kobe City (JP)

(72) Inventors: Hiroyuki Matsumoto, Frisco, TX (US); Takeshi Ogasawara, Kobe City (JP); Daizo Jito, Kobe City (JP); Takao Kokubu, Kobe City (JP)

(73) Assignee: SANYO ELECTRIC CO., LTD., Moriguchi-shi, Osaka (JP)

(21) Appl. No.: 13/981,534

(22) PCT Filed: Dec. 27, 2011
(86) PCT No.: PCT/JP2011/080300

§ 371 Date: Aug. 23, 2013

(30) Foreign Application Priority Data
Jan. 24, 2011 (JP) 2011-011532

(51) Int. Cl. H01M 4/13; H01M 4/139

(52) U.S. Cl. CPC H01M 4/13; H01M 4/139
USPC 429/211; 427/126.1

(57) ABSTRACT

An object of the present invention is to provide a positive electrode for a nonaqueous electrolyte secondary battery capable of significantly improving cycling characteristics while decreasing production cost, a method for producing the positive electrode, and a nonaqueous electrolyte secondary battery using the positive electrode. The positive electrode includes a positive-electrode current collector, and a positive-electrode mixture layer formed on at least one of the surfaces of the positive-electrode current collector, wherein the positive-electrode mixture layer contains a positive electrode active material, a binder, a conductive agent, and at least one compound selected from the compound group consisting of rare earth acetic acid compounds, rare earth nitric acid compounds, and rare earth sulfuric acid compounds.

### TECHNICAL FIELD

The present invention relates to a positive electrode for a nonaqueous electrolyte secondary battery, a method for producing the positive electrode, and a nonaqueous electrolyte secondary battery using the positive electrode.

### BACKGROUND ART

In recent years, reductions in size and weight of mobile information terminals such as a cellular phone, a notebook-size personal computer, PDA, and the like have been rapidly advanced, and batteries used as driving power supplies have been required to have higher capacity. Lithium ion batteries which are charged and discharged by movement of lithium ions between positive and negative electrodes in association with charge and discharge have a high energy density and high capacity, and are thus widely used as driving power supplies for the above-described mobile information terminals.

The mobile information terminals are liable to be further increased in power consumption with enhancement of functions such as a video replay function and a game function, and are strongly demanded to have higher capacity. A method for increasing the capacity of the nonaqueous electrolyte batteries is, for example, a method of increasing the capacity of an active material, a method of increasing the amount of an active material filling per unit volume, or a method of increasing the charge voltage of a battery. However, an increase in charge voltage of a battery easily causes the problem of easy decomposition of an electrolyte, and particularly, repeated charge-discharge cycles at high temperature produce the problem of decreasing a discharge capacity.

From the above-described viewpoint, a technique described below is proposed.

(1) A positive electrode active material having a surface coated with aluminum hydroxide using a solution of an aluminum nitrate salt in water is used. It is described that the cycling characteristics of a battery can be improved as a result (refer to Patent Literature 1 below).

Also, a technique described below is proposed for the purpose of enhancing safety of a battery during overcharge.

(2) By using a positive electrode containing lanthanum carbonate or erbium carbonate, gas is easily generated during overcharge, thereby promoting an operation of CID (refer to Patent Literature 2 below).

### CITATION LIST

### Patent Literature

PTL 1: Japanese Published Unexamined Patent Application No. 2009-218217
PTL 2: Japanese Published Unexamined Patent Application No. 10-125327

### SUMMARY OF INVENTION

### Technical Problem

However, when a positive electrode and a positive electrode active material are produced according to the proposal described above in (1), a production process is complicated to increase production cost. In addition, in the case of a positive electrode and a positive electrode active material produced according to the proposal described above in (2), gas is easily generated when a charge voltage is set to be high, and thus there is the problem of degrading cycling characteristics.

### Solution to Problem

The present invention includes a positive-electrode current collector and a positive-electrode mixture layer formed on at least one of the surfaces of the positive-electrode current collector, the positive-electrode mixture layer containing a positive electrode active material, a binder, a conductive agent, and at least one compound (may be referred to as a “rare earth compound” hereinafter) selected from the compound group consisting of acetic acid compounds of rare earths, nitric acid compounds of rare earths, and sulfuric acid compounds of rare earths.

### Advantageous Effects of Invention

According to the present invention, an excellent effect of being capable of significantly improving cycling characteristics is exhibited.

### BRIEF DESCRIPTION OF DRAWINGS

FIG. 1 is a front view of a nonaqueous electrolyte secondary battery according to an embodiment of the present invention.

FIG. 2 is a cross-sectional view taken along arrow line A-A in FIG. 1.

### DESCRIPTION OF EMBODIMENTS

The present invention includes a positive-electrode current collector and a positive-electrode mixture layer formed on at least one of the surfaces of the positive-electrode current collector, the positive-electrode mixture layer containing a positive electrode active material, a binder, a conductive agent, and at least one compound selected from the compound group consisting of rare earth acetic acid compounds, rare earth nitric acid compounds, and rare earth sulfuric acid compounds.

In the above-described configuration, even when a battery in a charged state is exposed to high temperature, decomposition of an electrolyte and deterioration of the positive electrode active material can be suppressed, and thus degradation in discharge performance can be suppressed even in repeated cycles. A conceivable reason for this is that when the rare earth compound is present in the positive electrode, the rare earth compound is partially present on the surfaces of the positive electrode active material and the conductive agent which accelerate oxidative decomposition of the electrolyte, thereby covering the surfaces. Therefore, the area of contact with the electrolyte on the surfaces of the positive electrode active material and the conductive agent can be decreased, and the influence of a transition metal contained in the positive electrode active material which activates decomposition reaction of the electrolyte can be suppressed (that is, the catalytic property of the positive electrode active material and the conductive agent is decreased). As a result, oxidative decomposition reaction of the electrolyte on the electrode active material and the conductive agent is suppressed.

A rare earth acetic acid compound and/or a rare earth sulfuric acid compound is preferably selected as the compound.

A rare earth acetic acid compound and a rare earth sulfuric acid compound are hardly corroded as compared with a rare earth nitric acid compound. Therefore, it is unnecessary to take a measure for preventing corrosion in an apparatus for producing a positive electrode, thereby decreasing the production cost of the positive electrode. The rare earth acetic acid compound is particularly preferred for reason of high solubility in an organic solvent.

The rare earth is preferably ytterbium and/or erbium.

This is because ytterbium and erbium are easily dissolved in an organic solvent.

The present invention includes a first step of preparing a positive-electrode slurry containing at least one rare earth compound selected from the compound group consisting of rare earth acetic acid compounds, rare earth sulfuric acid compounds, and rare earth nitric acid compounds, a positive electrode active material, a binder, a conductive agent, and an organic solvent, and a second step of applying and drying the positive electrode slurry on a positive-electrode current collector to form a positive electrode mixture layer on a surface of the positive-electrode current collector.

The inventors found that rare earth compounds are dissolved in organic solvents. Therefore, in the first step of preparing the positive electrode slurry containing the organic solvent, when the rare earth compound is added to the slurry, at least part of the rare earth compound is present in a state of being dissolved in the organic solvent, and is precipitated as the rare earth compound when the organic solvent is removed by drying after applying the positive electrode slurry. Therefore, the rare earth compound is simply added to the positive electrode slurry, and thus an increase in production cost due to complication of the production process can be prevented.

The rare earth compound dissolved in the organic solvent in the first step is precipitated in its initial state when the organic solvent is removed in the second step (for example, when a rare earth acetic acid compound is added, the compound is precipitated as the rare earth acetic acid compound). That is, unlike in a case where water is removed after a rare earth compound is dissolved in an aqueous solution, the compound is not precipitated as a rare earth hydroxide.

Usable examples of the rare earth compound include erbium nitrate, erbium acetate, ytterbium acetate, and hydrates thereof. When a hydrate is used, the hydrate may be directly added or may be added after being previously dried in vacuum at about 120° C.

The first step preferably includes a step of dissolving, in the organic solvent, at least one compound selected from the compound group consisting of rare earth acetic acid compounds, rare earth sulfuric acid compounds, and rare earth nitric acid compounds.

In preparing the positive electrode slurry, the rare earth compound may be added together with the positive electrode active material, the binder, and the conductive agent, but, in this case, the rare earth compound may not be sufficiently dissolved in the organic solvent. Therefore, a step of dissolving the rare earth compound in the organic solvent is separated provided to increase the solubility of the rare earth compound, and thus dispersibility of the rare earth compound is improved when the positive electrode is formed. Therefore, the effect of suppressing oxidative decomposition reaction of the electrolyte is further exhibited.

It is preferred that in the first step, at least one compound selected from the compound group consisting of rare earth acetic acid compounds, rare earth sulfuric acid compounds, and rare earth nitric acid compounds is dissolved in the organic solvent to prepare a solution, and the solution is mixed with the positive electrode active material and then mixed with the conductive agent and the binder.

The rare earth compound may be mixed with the organic solvent before or after the positive electrode active material is mixed with the conductive agent and the binder. However, when the solution of the rare earth compound dissolved in the organic solvent is mixed with the positive electrode active material before the conductive agent and the binder are mixed, the rare earth compound is easily uniformly precipitated (adhered) on the surface of the positive electrode active material, and thus reaction between the electrolyte and the positive electrode active material can be more effectively suppressed.

In order to uniformly precipitate the rare earth compound not only on the surface of the positive electrode active material but also on the surface of the conductive agent, a solution of the rare earth compound dissolved in the organic solvent may be mixed with the positive electrode active material and the conductive agent and then mixed with the binder.

The compound group is preferably selected as consisting of acetic acid compounds of rare earths and/or sulfuric acid compounds of rare earths.

The reason for this is the same as described above.

As the organic solvent, N-methyl-2-pyrrolidone (may be abbreviated as “NMP” hereinafter) is preferably used.

This is because NMP can be easily used as a solvent for preparing slurry because NMP is low-priced and easily dissolves not only the rare earth compound but also the binder.

When NMP is used as the organic solvent, the binder soluble in NMP is preferably used and, for example, PVdF (polyvinylidene fluoride) is exemplified.

The rare earth compound need not be completely dissolved in the organic solvent, and the rare earth compound may be mixed with the positive electrode active material in a state where the rare earth compound is partially not dissolved in the organic solvent. However, when the solution of the rare earth compound sufficiently dissolved in the organic solvent is mixed with the positive electrode active material, the rare earth compound is more easily uniformly precipitated (adhered) on the surface of the positive electrode active material, and thus reaction between the electrolyte and the positive electrode active material can be more effectively suppressed. In view of this, the rare earth compound having high solubility in the organic solvent is preferably used. As described above, it is more effective that the solution of the rare earth compound sufficiently dissolved in the organic solvent is mixed with the positive electrode active material before being mixed with the conductive agent and the binder.

In addition, Ketjen black, acetylene black, carbon nanotubes, vapor growth carbon, or the like can be used as the conductive agent, and when mixed with the positive electrode active material, the conductive agent may be previously dispersed in a NMP solution containing the binder.

Further, the surface of the positive electrode active material may be previously coated with the conductive agent or the conductive agent may be previously adhered to the surface. Examples of a method for coating the surface of the positive electrode active material with the conductive agent or adhering the conductive agent to the surface include a method of coating the positive electrode active material with a solution containing a saccharide dissolved therein and then carbonizing the saccharide by heat treatment, a coating method of mechanically mixing the conductive agent and the positive electrode active material, and the like.

However, the organic solvent is not limited to NMP and may be an amine solvent such as N,N-dimethylaminopropylamine, diethylenetriamine, or the like, an ether solvent such as tetrahydrofuran or the like, a ketone solvent such as methyl ethyl ketone or the like, an ester solvent such as methyl acetate or the like, an amide solvent such as dimethylacetamide or the like, or the like.

A nonaqueous electrolyte secondary battery includes the above-described positive electrode, a negative electrode, and a nonaqueous electrolyte.

### (Other Matters)

(1) The positive electrode active material used in the present invention is a lithium-transition metal oxide such as lithium cobalt oxide, lithium nickel-cobalt-manganese oxide, lithium nickel-cobalt-aluminum oxide, lithium nickel-cobalt oxide, lithium nickel-manganese oxide, lithium nickel oxide, lithium manganese oxide, lithium cobalt-manganese oxide, or the like, an olivine-type transition metal oxide containing iron, manganese, or the like (represented by LiMPO₄ wherein M is selected from Fe, Mn, Co, and Ni), or the like, and a known positive electrode can be used.

(2) The amount of the rare earth compound contained in the positive electrode is preferably 0.01% by mass or more and less than 0.5% by mass in terms of rare earth element relative to the amount of the positive electrode active material. With the amount of less than 0.01% by mass, the amount of the rare earth compound is excessively small, and thus the effect of the rare earth compound added may not be sufficiently exhibited. On the other hand, with the amount exceeding 0.5% by mass, the surface of the positive electrode active material may be excessively coated with the rare earth compound which is hardly directly involved in charge-discharge reaction, thereby possibly decreasing discharge performance.

(3) The positive electrode active material may contain a substance of Al, Mg, Ti, Zr, or the like dissolved therein or located at grain boundaries. Besides the rare earth compound, a compound of Al, Mg, Ti, Zr, or the like may be adhered to the surface of the positive electrode active material. This is because even when such a compound is adhered, contact between the electrolyte and the positive electrode active material can be suppressed.

(4) The solvent of the nonaqueous electrolyte used in the present invention is not limited, and a solvent generally used for nonaqueous electrolyte secondary batteries can be used. Examples thereof include cyclic carbonates such as ethylene carbonate, propylene carbonate, butylene carbonate, vinylene carbonate, and the like; linear carbonates such as dimethyl carbonate, methylethyl carbonate, diethyl carbonate, and the like; ester-containing compounds such as methyl acetate, ethyl acetate, propyl acetate, methyl propionate, ethyl propionate, γ-butyrolactone, and the like; sulfone group-containing compounds such as propanesultone and the like; ether-containing compounds such as 1,2-dimethoxyethane, 1,2-diethoxyethane, tetrahydrofuran, 1,2-dioxane, 1,4-dioxane, 2-methyltetrahydrofuran, and the like; nitrile-containing compounds such as butyronitrile, valeronitrile, n-heptanenitrile, succinonitrile, glutarnitrile, adiponitrile, pimelonitrile, 1,2,3-propanetricarbonitrile, 1,3,5-pentanetricarbonitrile, and the like; amide-containing compounds such as dimethylformamide and the like. In particular, these solvents each partially substituted by F for H can be preferably used. These solvents can be used alone or in combination of two or more, and in particular, a solvent containing a combination of a cyclic carbonate and a linear carbonate, and a solvent further containing a small amount of nitrile-containing compound or ether-containing compound in combination with a cyclic carbonate and a linear carbonate are preferred.

On the other hand, a solute which has been used can be used as a solute of the nonaqueous electrolyte, and examples thereof include LiPF₆, LiBF₄, LiN(SO₂CF₃)₂, LiN(SO₂C₂F₅)₂, LiPF₆₋ₓ(CₙF₂ₙ₋₁)ₓ (wherein 1<x<6, N=1 or 2), and the like. These may be used alone or as a mixture of two or more. The concentration of the solute is not particularly limited but is preferably 0.8 to 1.5 mol per liter of the electrolyte.

(5) A negative electrode which has been used can be used as the negative electrode in the present invention. In particular, a lithium-absorbable and desorbable carbon material, and a metal capable of forming an alloy with lithium or an alloy compound containing the metal can be used.

Examples of the carbon material which can be used include graphites such as natural graphite, non-graphitizable carbon, artificial graphite, and the like; cokes, and the like. An alloy compound containing at least one metal capable of forming an alloy with lithium can be used. In particular, silicon and tin are preferred as an element capable of forming an alloy with lithium, and silicon oxide, tin oxide, and the like, which contain oxygen bonded to the elements, can also be used. Also, a mixture of the carbon material and a silicon or tin compound can be used.

Besides the above-described materials, a material having lower energy density but a higher charge-discharge potential versus metallic lithium, such as lithium titanate, than that of carbon materials can be used as a negative electrode material.

(6) A layer composed of an inorganic filler, which has been used, can be formed at an interface between the positive electrode and a separator or an interface between the negative electrode and a separator. As the filler, titanium, aluminum, silicon, magnesium, and the like, which have been used, can be used alone, used as an oxide or phosphoric acid compound containing two or more of these elements, or used after being surface-treated with a hydroxide or the like.

Usable examples of a method for forming the filler layer include a forming method of directly applying a filler-containing slurry to the positive electrode, the negative electrode, or the separator, a method of bonding a sheet made of the filler to the positive electrode, the negative electrode, or the separator, and the like.

(7) A separator which has been used can be used as the separator in the present invention. Specifically, not only a separator composed of polyethylene but also a separator including a polypropylene layer formed on a surface of a polyethylene layer and a polyethylene separator including a resin such as an aramid resin or the like applied to a surface thereof may be used.

### EXAMPLES

A positive electrode for a nonaqueous electrolyte secondary battery and a battery according to the present invention are described below. The positive electrode for a nonaqueous electrolyte secondary battery and the battery according to the present invention not limited to examples described below, and appropriate modification can be made without changing the gist of the present invention.

### Example 1

### Formation of Positive Electrode

### [Preparation of Erbium Acetate-NMP Solution]

A solution was prepared by dissolving 0.86 g of erbium acetate tetrahydrate [Er(CH₃COO)₃.4H₂O] in 40 g of NMP (N-methyl-2-pyrrolidone).

### [Preparation of Positive-Electrode Slurry]

Lithium cobalt oxide containing Al and Mg each dissolved at 0.1 mol % was used as a positive electrode active material, and the above-described NMP solution containing erbium acetate dissolved therein was mixed with 500 g of the positive electrode active material. Next, the NMP solution was mixed with carbon black (acetylene black) powder (average particle diameter: 40 nm) used as a conductive agent and polyvinylidene fluoride (PVdF) used as a binder, and the resultant mixture was dispersed to prepare a positive electrode slurry (first step). In this step, a ratio by mass between the positive electrode active material, the conductive agent, and the binder was 95:2.5:2.5.

Next, the positive electrode slurry was applied to both surfaces of a positive-electrode current collector composed of an aluminum foil and dried at 120° C. (second step). As a result, erbium acetate was contained in positive electrode mixture layers formed on both surfaces of the positive-electrode current collector. Then, rolling was performed with a rolling mill to produce a positive electrode. In the positive electrode, the ratio of erbium acetate to the positive electrode active material was 0.07% by mass in terms of erbium.

### [Formation of Negative Electrode]

First, artificial graphite serving as a negative electrode active material, CMC (carboxymethyl cellulose sodium) serving as a dispersant, and SBR (styrene-butadiene rubber) serving as a binder were mixed at a mass ratio of 98:1:1 in an aqueous solution to prepare a negative electrode slurry. Next, the negative electrode slurry was uniformly applied to both surfaces of a negative-electrode current collector composed of a copper foil, dried, and then rolled with a rolling mill to produce a negative electrode including negative electrode mixture layers formed on both surfaces of the negative-electrode current collector. The packing density of the negative electrode active material in the negative electrode was 1.70 g/cm³.

### [Preparation of Nonaqueous Electrolyte]

Lithium hexafluorophosphate (LiPF₆) was dissolved at a ratio of 1.0 mol/l in a mixed solvent prepared by mixing ethylene carbonate (EC) and methylethyl carbonate (MEC) at a volume ratio of 3:7, preparing a nonaqueous electrolyte.

### [Formation of Battery]

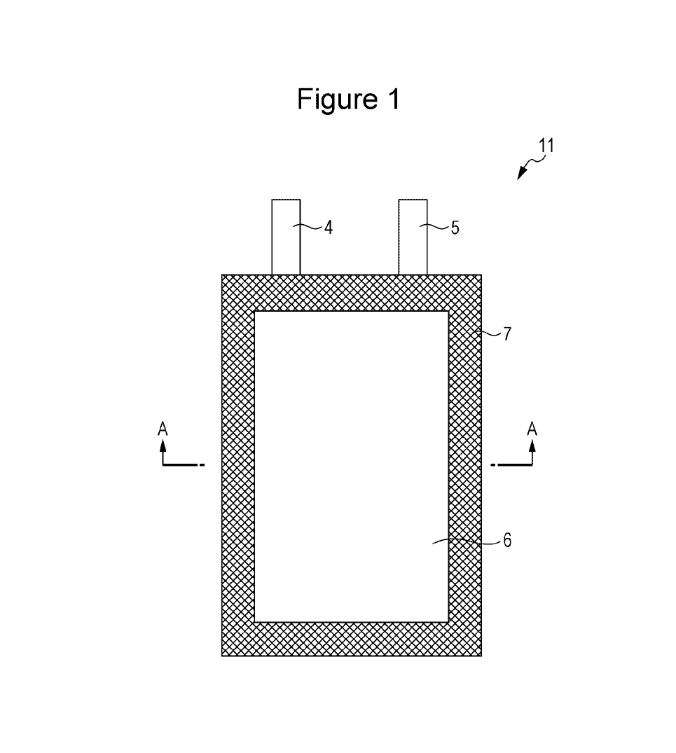

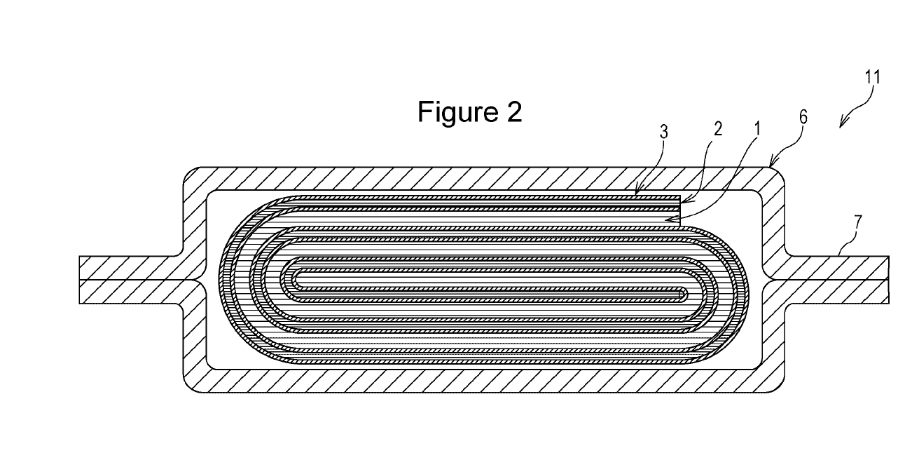

A lead terminal was attached to each of the positive and negative electrodes, and the positive and negative electrodes with a separator disposed therebetween were spirally coiled. Then, a core was removed to form a spirally coiled electrode body, and the electrode body was further pressed to form a flat electrode body. Next, the flat electrode body and the nonaqueous electrolyte were disposed in an outer case made of an aluminum laminate, forming a flat nonaqueous electrolyte secondary battery having a structure shown in FIGS. 1 and 2. The secondary battery had a size of 3.6 mm×35 mm×62 mm, and when the secondary battery was charged to 4.40 V and discharged to 2.75 V, a discharge capacity was 750 mAh.

As shown in FIGS. 1 and 2, the nonaqueous electrolyte secondary battery 11 has a specific structure in which a positive electrode 1 and a negative electrode 2 are disposed to face each other with a separator 3 therebetween, and a flat-shape electrode body including the positive and negative electrodes 1 and 2 and the separator 3 is impregnated with the electrolyte. The positive and negative electrodes 1 and 2 are connected to a positive-electrode current collector tab 4 and a negative-electrode current collector tab 5, respectively, thereby forming a structure chargeable and dischargeable as a secondary battery. The electrode body is disposed in a receiving space of an aluminum laminate outer case 6 including an opening 7 with a heat-sealed periphery.

The battery formed as described above is referred to as “battery A1” hereinafter.

### Example 2

A battery was formed by the same method as in Example 1 except that in preparing a positive electrode slurry, lithium cobalt oxide was mixed with a conductive agent and a binder, and then mixed with a NMP solution of erbium acetate tetrahydrate (may be simply referred to as “erbium acetate” hereinafter) dissolved therein. The ratio of erbium acetate to the positive electrode active material was 0.07% by mass in terms of erbium.

The thus-formed battery is referred to as “battery A2” hereinafter.

### Example 3

A battery was formed by the same method as in Example 1 except that in forming a positive electrode, 0.87 g of ytterbium acetate tetrahydrate (may be simply referred to as “ytterbium acetate” hereinafter) was used in place of erbium acetate. The ratio of ytterbium acetate to the positive electrode active material was 0.07% by mass in terms of ytterbium.

The thus-formed battery is referred to as “battery A3” hereinafter.

### Example 4

A battery was formed by the same method as in Example 1 except that in forming a positive electrode, 0.93 g of erbium nitrate pentahydrate (may be simply referred to as “erbium nitrate” hereinafter) was used in place of erbium acetate. The ratio of erbium nitrate to the positive electrode active material was 0.07% by mass in terms of erbium.

The thus-formed battery is referred to as “battery A4” hereinafter.

### Example 5

A battery was formed by the same method as in Example 1 except that in forming a positive electrode, 0.78 g of erbium sulfate octahydrate (may be simply referred to as “erbium sulfate” hereinafter) was used in place of erbium acetate. The ratio of erbium sulfate to the positive electrode active material was 0.04% by mass in terms of erbium.

The thus-formed battery is referred to as “battery A5” hereinafter.

### Example 6

A battery was formed by the same method as in Example 1 except that in forming a positive electrode, 0.78 g of erbium sulfate octahydrate and 0.86 g of erbium acetate tetrahydrate were used in place of erbium acetate. The ratios of erbium sulfate and erbium acetate to the positive electrode active material were 0.04% by mass and 0.07% by mass in terms of erbium, respectively.

The thus-formed battery is referred to as “battery A6” hereinafter.

### Comparative Example

A battery was formed by the same method as in Example 1 except that in forming a positive electrode, erbium acetate was not added.

The thus-formed battery is referred to as “battery Z” hereinafter.

### Experiment 1

Each of the batteries A1 to A6 and Z was charged and discharged under conditions described below to measure 45° C. cycling characteristics. The results are shown in Table 1.

### [Charge-Discharge Condition in First Cycle]

Charge Condition in First Cycle

Constant-current charge with a current of 1.0 lt (750 mA) was performed until the battery voltage was 4.40 V, and further constant-voltage charge with a voltage of 4.40 V was performed until a current value was 37.5 mA.

Discharge Condition in First Cycle

Constant-current discharge with a current of 1.0 lt (750 mA) was performed until the battery voltage was 2.75 V.

Resting

A rest interval between the charge and discharge was 10 minutes.

### [Condition for 45° C. Cycling Test]

The battery was maintained in a constant-temperature oven at 45° C. for 1 hour and then subjected to a charge-discharge cycling test once under the conditions described above to measure discharge capacity Q1 (discharge capacity Q1 in the first cycle). Then, further charge-discharge cycles at 45° C. were performed to determine discharge capacity Q2 in each of the cycles. Then, when a ratio of discharge capacity Q2 to discharge capacity Q1 was 60%, a number of cycles was determined.

TABLE 1

| | | | 45° C. |
|---|---|---|---|
| | | Timing of mixing | cycling |
| | | NMP solution of rare | characteristic |
| Type of | Compound | earth compound | (number |
| battery | contained | dissolved therein | of cycles) |
| Battery A1 | Erbium acetate | Before mixing conductive | 280 |
| | | agent and binder | |
| Battery A2 | Erbium acetate | After mixing conductive | 270 |
| | | agent and binder | |
| Battery A3 | Ytterbium | Before mixing conductive | 255 |
| | acetate | agent and binder | |
| Battery A4 | Erbium nitrate | Before mixing conductive | 280 |
| | | agent and binder | |
| Battery A5 | Erbium sulfate | Before mixing conductive | 200 |
| | | agent and binder | |
| Battery A6 | Erbium | Before mixing conductive | 290 |
| | sulfate + | agent and binder | |
| | erbium acetate | | |
| Battery Z1 | — | | 130 |

Table 1 indicates that in the batteries A1 to A3 each using the positive electrode containing a rare earth acetic acid compound such as erbium acetate or ytterbium acetate, the battery A4 using the positive electrode containing a rare earth nitric acid compound such as erbium nitrate, the battery A5 using the positive electrode containing a rare earth sulfuric acid compound such as erbium sulfate, and the battery A6 using the positive electrode containing a rare earth sulfuric acid compound such as erbium sulfate and a rare earth acetic acid compound such as erbium acetate, significant improvement is observed in the cycling characteristics at high temperature as compared with the battery Z using the positive electrode containing none of a rare earth acetic acid compound, a rare earth nitric acid compound, a rare earth sulfuric acid compound, and the like. The reason for this is considered to be that when a rare earth acetic acid compound, a rare earth nitric acid compound, a rare earth sulfuric acid compound, or the like is present on the surfaces of the positive electrode active material and the conductive agent, side reaction of the electrolyte with the positive electrode active material and the conductive agent is suppressed.

A comparison between the battery A1 and the battery A2 reveals that the battery A1 formed by mixing the positive electrode active material with the NMP solution of erbium acetate dissolved therein and then mixing with the conductive agent and the binder and dispersing them is more improved in cycling characteristics than the battery A2 formed by kneading the positive electrode active material, the conductive agent, and the binder and then mixing with the NMP solution of erbium acetate dissolved therein. The reason for this is supposed to be that when the positive electrode active material is previously mixed with the NMP solution of erbium acetate dissolved therein, erbium acetate is more easily uniformly precipitated on the surface of the positive electrode active material.

Also, the battery A6 using the positive electrode containing erbium sulfate and erbium acetate is more improved in high-temperature cycling characteristics than the battery A5 using the positive electrode containing only erbium sulfate and the battery A1 using the positive electrode containing only erbium acetate. The reason for this is considered to be that when in the battery A6, the synergic effect obtained by using both a rare earth sulfuric acid compound and a rare earth acetic acid compound, the effect obtained by increase in the amount of a rare earth compound added, and the like are exhibited.

### Experiment 2

In order to confirm that the material precipitated on the surface of the positive electrode active material is the same as that added for preparing the positive electrode slurry, an experiment described below was conducted. Since the positive electrode active material containing a transition metal was alkaline, sodium hydroxide (NaOH) was used as a material alternate to the positive electrode active material.

Specifically, no precipitate was produced even by mixing solid sodium hydroxide with a solution prepared by dissolving erbium acetate tetrahydrate in NMP. Therefore, hydroxide is not produced by reaction between water in erbium acetate tetrahydrate and a solid alkali component in the positive electrode active material, and consequently, erbium acetate is produced directly on the surface of the positive electrode active material during drying (removal of NMP). However, when a 10 mass % aqueous sodium hydroxide solution is added in place of solid sodium hydroxide, erbium hydroxide is produced. Therefore, when a solution prepared by dissolving erbium acetate tetrahydrate in water is used, erbium hydroxide is produced on the surface of the positive electrode active material.

### INDUSTRIAL APPLICABILITY

The present invention can be expected for development of driving power supplies for mobile information terminals, for example, cellular phones, notebook-size personal computers, PDAs, and the like, and driving power supplies for high output, for example, HEVs and electric tools.

### REFERENCE SIGNS LIST

1: positive electrode
2: negative electrode
3: separator
4: positive-electrode current collector tab
5: negative-electrode current collector tab
6: aluminum laminate outer case

1-9. (canceled)

10. A positive electrode for a nonaqueous electrolyte secondary battery comprising:
a positive-electrode current collector; and
a positive-electrode mixture layer formed on at least one of the surfaces of the positive-electrode current collector,
wherein the positive-electrode mixture layer contains a positive electrode active material, a binder, a conductive agent, and at least one compound selected from the compound group consisting of rare earth acetic acid compounds, rare earth nitric acid compounds, and rare earth sulfuric acid compounds.

11. The positive electrode for a nonaqueous electrolyte secondary battery according to claim 10, wherein a rare earth acetic acid compound and/or a rare earth sulfuric acid compound is selected as the compound.

12. The positive electrode for a nonaqueous electrolyte secondary battery according to claim 10, wherein the rare earth is ytterbium and/or erbium.

13. The positive electrode for a nonaqueous electrolyte secondary battery according to claim 11, wherein the rare earth is ytterbium and/or erbium.

14. A method for producing a positive electrode for a nonaqueous electrolyte secondary battery comprising:
a first step of preparing a positive electrode slurry containing at least one compound selected from the compound group consisting of rare earth acetic acid compounds, rare earth nitric acid compounds, and rare earth sulfuric acid compounds, a positive electrode active material, a binder, a conductive agent, and an organic solvent; and
a second step of applying the positive electrode slurry on a positive-electrode current collector and drying the slurry to form a positive electrode mixture layer on a surface of the positive-electrode current collector.

15. The method for producing a positive electrode for a nonaqueous electrolyte secondary battery according to claim 14, wherein the first step includes a step of dissolving the at least one compound selected from the compound group consisting of rare earth acetic acid compounds, rare earth nitric acid compounds, and rare earth sulfuric acid compounds in the organic solvent.

16. The method for producing a positive electrode for a nonaqueous electrolyte secondary battery according to claim 15, wherein in the first step, a solution prepared by dissolving the at least one compound selected from the compound group consisting of rare earth acetic acid compounds, rare earth nitric acid compounds, and rare earth sulfuric acid compounds in the organic solvent is mixed with the positive electrode active material and then mixed with the conductive agent and the binder.

17. The method for producing a positive electrode for a nonaqueous electrolyte secondary battery according to claim 14, wherein rare earth acetic acid compounds and/or rare earth sulfuric acid compounds are selected as the compound group.

18. The method for producing a positive electrode for a nonaqueous electrolyte secondary battery according to claim 15, wherein rare earth acetic acid compounds and/or rare earth sulfuric acid compounds are selected as the compound group.

19. The method for producing a positive electrode for a nonaqueous electrolyte secondary battery according to claim 16, wherein rare earth acetic acid compounds and/or rare earth sulfuric acid compounds are selected as the compound group.

20. The method for producing a positive electrode for a nonaqueous electrolyte secondary battery according to claim 14, wherein N-methyl-2-pyrrolidone is used as the organic solvent.

21. The method for producing a positive electrode for a nonaqueous electrolyte secondary battery according to claim 15, wherein N-methyl-2-pyrrolidone is used as the organic solvent.

22. The method for producing a positive electrode for a nonaqueous electrolyte secondary battery according to claim 16, wherein N-methyl-2-pyrrolidone is used as the organic solvent.

23. The method for producing a positive electrode for a nonaqueous electrolyte secondary battery according to claim 17, wherein N-methyl-2-pyrrolidone is used as the organic solvent.

24. The method for producing a positive electrode for a nonaqueous electrolyte secondary battery according to claim 18, wherein N-methyl-2-pyrrolidone is used as the organic solvent.

25. The method for producing a positive electrode for a nonaqueous electrolyte secondary battery according to claim 19, wherein N-methyl-2-pyrrolidone is used as the organic solvent.

26. A nonaqueous electrolyte secondary battery comprising the positive electrode for a nonaqueous electrolyte secondary battery according to claim 10, a negative electrode, and a nonaqueous electrolyte.

27. A nonaqueous electrolyte secondary battery comprising the positive electrode for a nonaqueous electrolyte secondary battery according to claim 11, a negative electrode, and a nonaqueous electrolyte.

28. A nonaqueous electrolyte secondary battery comprising the positive electrode for a nonaqueous electrolyte secondary battery according to claim 12, a negative electrode, and a nonaqueous electrolyte.

29. A nonaqueous electrolyte secondary battery comprising the positive electrode for a nonaqueous electrolyte secondary battery according to claim 13, a negative electrode, and a nonaqueous electrolyte.
